(19) United States
(12) Patent Application Publication
(10) Pub. No.: US 2012/0210690 A1
(43) Pub. Date: Aug. 23, 2012

(54) EXTENDABLE JOINTED ARM FOR ENABLING A HAY BALER TO PULL A HAY RAKE DURING BOTH EASY TRANSPORT AND SIMULTANEOUS OPERATION OF THE HAY BALER AND THE HAY RAKE

(76) Inventors: Douglas Marvin Gladin, JR., Gordon, GA (US); Douglas Marvin Gladin, Milledgeville, GA (US)

(21) Appl. No.: 13/033,593

(22) Filed: Feb. 23, 2011

(51) Int. Cl. A01D 89/00

(52) U.S. Cl. 56/218

(57) ABSTRACT

An extendable jointed arm is disclosed, for enabling a hay baler to pull a hay rake during both easy transport, and simultaneous operation, of the hay baler and the hay rake. The extendable arm can be attached to a standard hay baler and a standard hay rake, and can be moved between an extended state ideal for simultaneous operation of the hay baler and hay rake, and a non-extended state ideal for easy transport of the hay baler and hay rake. The extendable arm includes at least a baler arm portion and a rake arm portion, and one or more arm extenders capable of pivoting the rake arm portion relative to the baler arm portion about an articulated joint. The extendable arm can also include a locking mechanism and/or supporting wheels. The extendable arm can also include a rake lifter for lifting the rake for easy transport.

### FIELD

The invention relates generally to farm equipment, and more specifically to equipment for raking and baling hay.

### BACKGROUND

Hay serves as important animal fodder, and in particular as fodder for grazing livestock such as horses, cattle, goats and sheep. It is relied upon heavily when grazing cannot be accomplished through pasture alone, due to such reasons as inadequate quantity or quality of grazable pasture, or some other lack of access to grazable pasture.

Hay is optimally gathered when its nutrient value is the highest. After hay is cut, typically it is raked into rows and then baled. The traditional approach to raking and baling is to rake hay into rows (often referred to as “windrows”) with a rake assembly towed by a tractor, and then bale the rows with a separate baler machine also towed by a tractor (either the same tractor that towed the rake assembly, or a different tractor).

Using two separate tractors to rake and then bale hay requires extra equipment and energy. Therefore, devices for raking and baling hay at the same time have been proposed and are known in the art. However, these devices typically require costly modification of existing equipment, or purchase of expensive new equipment.

### SUMMARY

An extendable jointed arm enables a hay baler to pull a hay rake during both easy transport, and simultaneous operation, of the hay baler and the hay rake. The extendable arm can be attached to a standard hay baler and a standard hay rake, and can be moved between an extended state ideal for simultaneous operation of the hay baler and hay rake, and a non-extended state ideal for easy transport of the hay baler and hay rake.

The extendable arm includes at least a baler arm portion and a rake arm portion, and one or more arm extenders capable of pivoting the rake arm portion relative to the baler arm portion about an articulated joint. The extendable arm can also include a locking mechanism and/or supporting wheels. The extendable arm can also include a rake lifter for lifting the rake for easy transport.

One general aspect of the invention is an extendable jointed arm, for enabling a hay baler to pull a hay rake during both easy transport, and simultaneous operation, of the hay baler and the hay rake, the extendable jointed arm including: a baler arm portion, the baler arm portion being configured to attach to a hay baler; a rake arm portion, the rake arm portion being configured to attach to and support a hay rake; at least one articulated joint, the baler arm portion and the rake arm portion being connected via the at least one articulated joint; and at least one arm extender, cooperative with the at least one articulated joint, the at least one arm extender being capable of bending the at least one articulated joint, thereby moving the extendable arm between a non-extended state and an extended state, the extendable arm positioning the hay rake and the hay baler relative to each other so as to enable the hay rake and the hay baler to operate simultaneously, when in the extended state, and the extendable arm positioning the hay rake behind the hay baler for facilitating transport of the rake and hay baler, when in the non-extended state.

In some embodiments, the at least one arm extender is in communication with a rake lifter, the rake lifter being capable of lifting wheels of the hay rake. In some embodiments, the extendable arm is capable of positioning the rake substantially behind the baler, when the extendable arm is in the non-extended state. In some embodiments, the extendable arm is capable of positioning the rake relative to the baler so as to enable the rake to rake a row of hay parallel to a row of hay being baled by the baler, when the extendable arm is in the extended state.

In some embodiments, the rake arm portion is directly connected to the baler arm portion via a single articulated joint. In some embodiments, the extendable arm further includes at least one intermediate arm portion connecting the baler arm portion with the rake arm portion.

In some embodiments, the baler arm portion is rigidly attached to the front of the baler, so that the baler arm portion is immovable relative to the baler. In some embodiments, the rake arm portion is pivotably attached to the rake via a hinge, so that the rake arm portion is in pivotable relationship with the rake.

In some embodiments, movement of the at least one arm extender is power-assisted. In some embodiments, the at least one arm extender includes a powered hydraulic cylinder or a powered pneumatic cylinder.

In some embodiments, the at least one arm extender is manually movable. In some embodiments, the at least one arm extender includes a hand crank.

In some embodiments, the extendable arm further includes a locking mechanism capable of locking the extendable arm into position in at least one of: the non-extended state; and the extended state. In some embodiments, the baler arm portion is straight, angled, or curved. In some embodiments, the rake arm portion is straight, angled, or curved.

In some embodiments, metal is used to make the baler arm portion and/or the rake arm portion. In some embodiments, at least one wheel supporting the rake arm portion and/or the baler arm portion. In some embodiments, the at least one wheel is a caster wheel. In some embodiments, the at least one wheel supports the rake arm portion, and in some embodiments, the at least one wheel supports the baler arm portion.

### BRIEF DESCRIPTION OF THE DRAWINGS

The invention will be more fully understood with reference to the following drawings:

FIG. 1 is a top view of an embodiment of the extendable arm connecting a hay baler to a hay rake, the hay rake creating an initial row of hay;

FIG. 2 is a top view of the embodiment of FIG. 1, the hay baler creating a sequence of bales by baling the initial row of hay, as the hay rake creates a second row of hay parallel to the newly created sequence of bales;

FIG. 3A is an oblique view of an embodiment of the extendable arm connecting a hay baler to a hay rake, the baler, arm and rake together constituting a rake-arm-baler assembly, with the extendable arm in an extended state and the rake in a down position;

FIG. 3B is another oblique view of the rake-arm-baler assembly of FIG. 3A, with the extendable arm moving into a non-extended state, and the rake moving into an up position;

FIG. 3C is another oblique view of the rake-arm-baler assembly of FIG. 3A, with the extendable arm in a non-extended state, and the rake in an up position;

FIG. 4 is an oblique view of an embodiment of the extendable arm that is not connected to any other equipment;

FIG. 5 is an exploded view of the embodiment of FIG. 4, showing the separate elements of the extendable arm;

FIG. 6 is an oblique view of an alternative embodiment of the extendable arm;

FIG. 7 is an oblique view of another alternative embodiment of the extendable arm; and

FIG. 8 is a flowchart detailing the steps of operation of the extendable arm in the context of its use with a hay baler and a hay rake.

### DETAILED DESCRIPTION

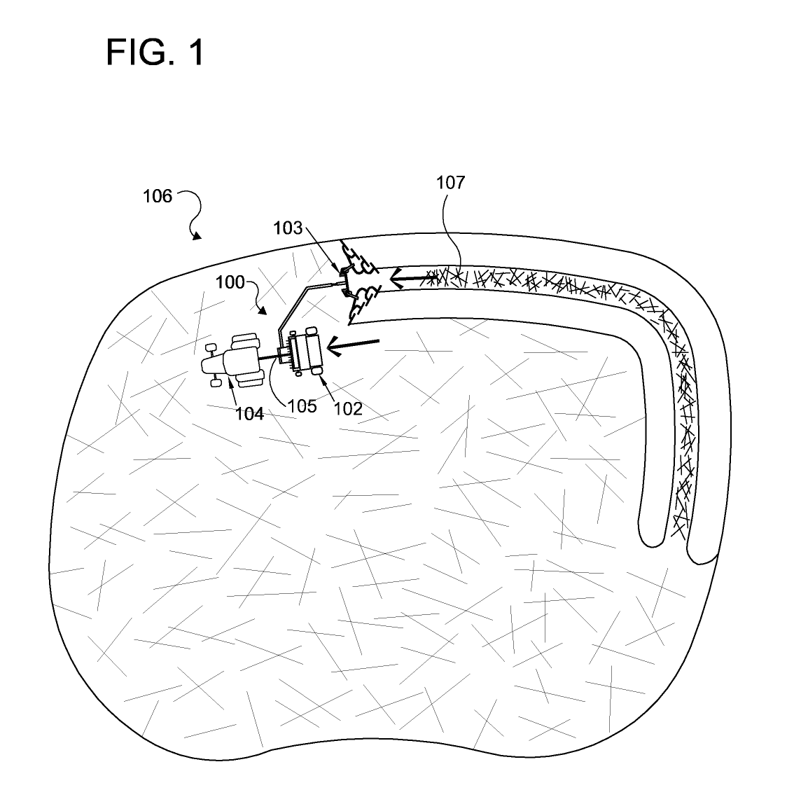

FIG. 1 is a top view of an embodiment of the extendable arm connecting a hay baler to a hay rake, showing an early stage of use of the extendable arm. In the embodiment shown, the extendable arm 100 connects the rake 103 to the right side of the baler 102, thereby enabling parallel operation of the baler 102 and the rake 103. In the embodiment shown, the baler 102 is being driven by a tractor 104 by a baler towing arm 105. The extendable arm 100 connects the rake 103 to the baler 102, thereby enabling the baler 102 to pull the rake 103. In the embodiment shown, the baler 102 is initially driven counterclockwise, enabling the rake 103 to rake a perimeter area of a hayfield 106, thereby creating a first row 107 along the perimeter of the field 106.

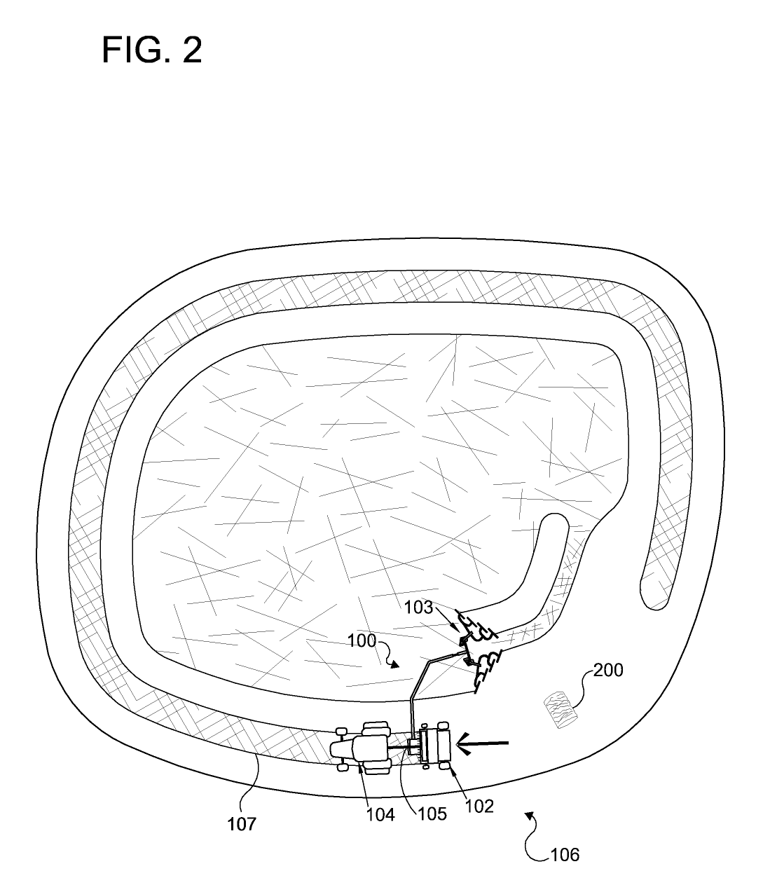

FIG. 2 is a top view of an embodiment of the extendable arm connecting a hay baler to a hay rake, showing a later stage of use of the extendable arm facilitating simultaneous use of the baler and rake. In the embodiment shown, the rake 103 and baler 102 simultaneously rake and bale the hayfield 106 respectively. Once the first row 107 has been raked in the manner shown and described in connection with FIG. 1, the baler 102 is then driven clockwise through the previously raked windrow 107, thereby baling the first windrow 107.

A bale of hay 200 produced from the baler 102 is shown. At the same time, the rake 103 is positioned by the extendable arm 100 so as to enable the rake 103 to rake a second, inner row 202 which is interior to the first row 107 along the perimeter of the field 106. In this manner, the baler 102 and rake 103 can operate simultaneously within the hayfield 106. For the remainder of the raking and baling of the field 106, the baler and rake are now continuously driven clockwise. With each new lap traveled around the field 106, the rake 103 is able to rake a new row interior to the previous row, while the baler 102 bales the previously raked row 107.

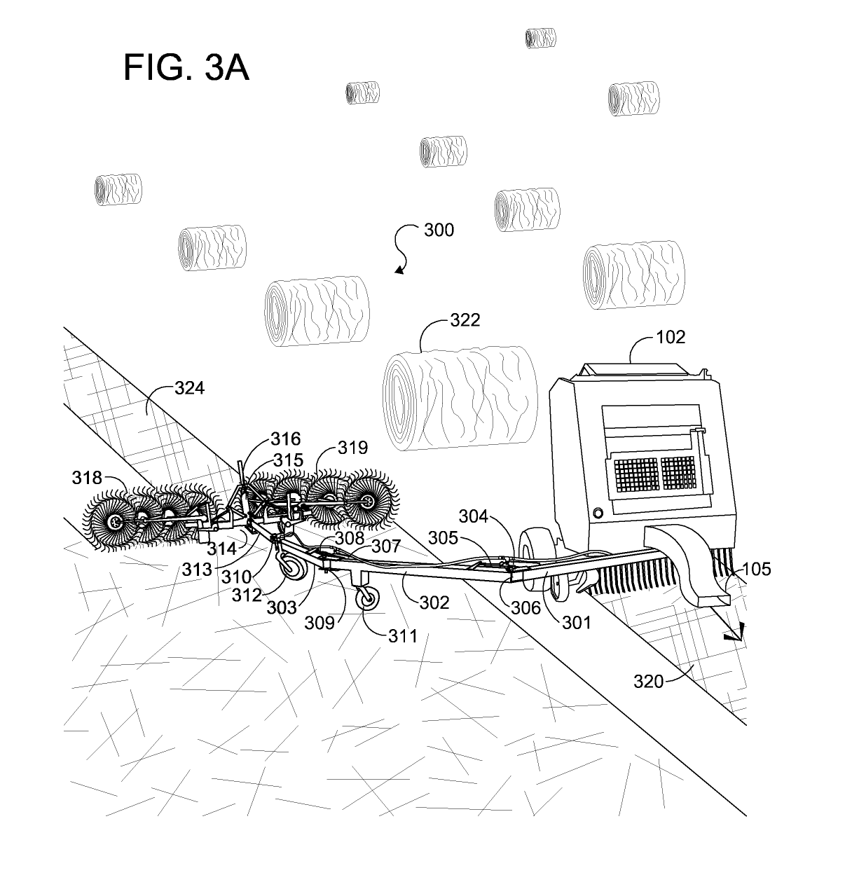

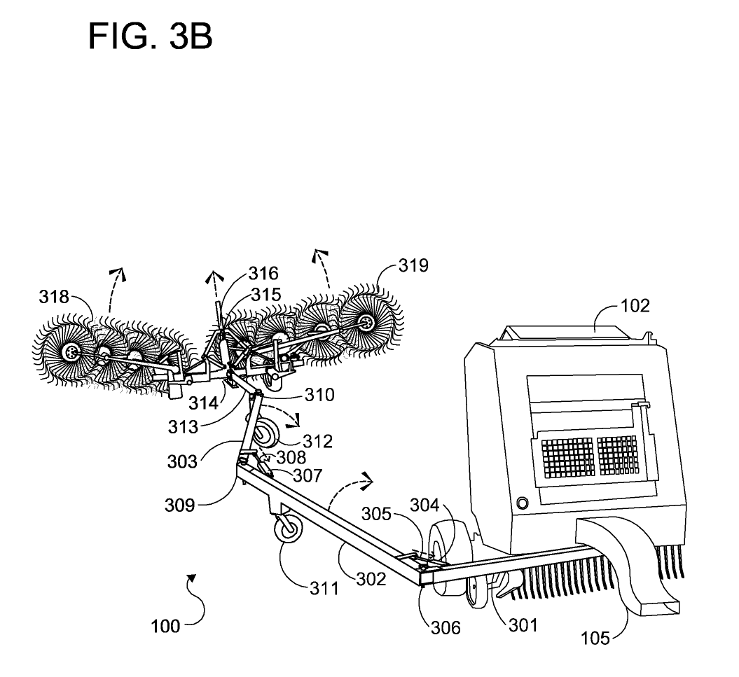

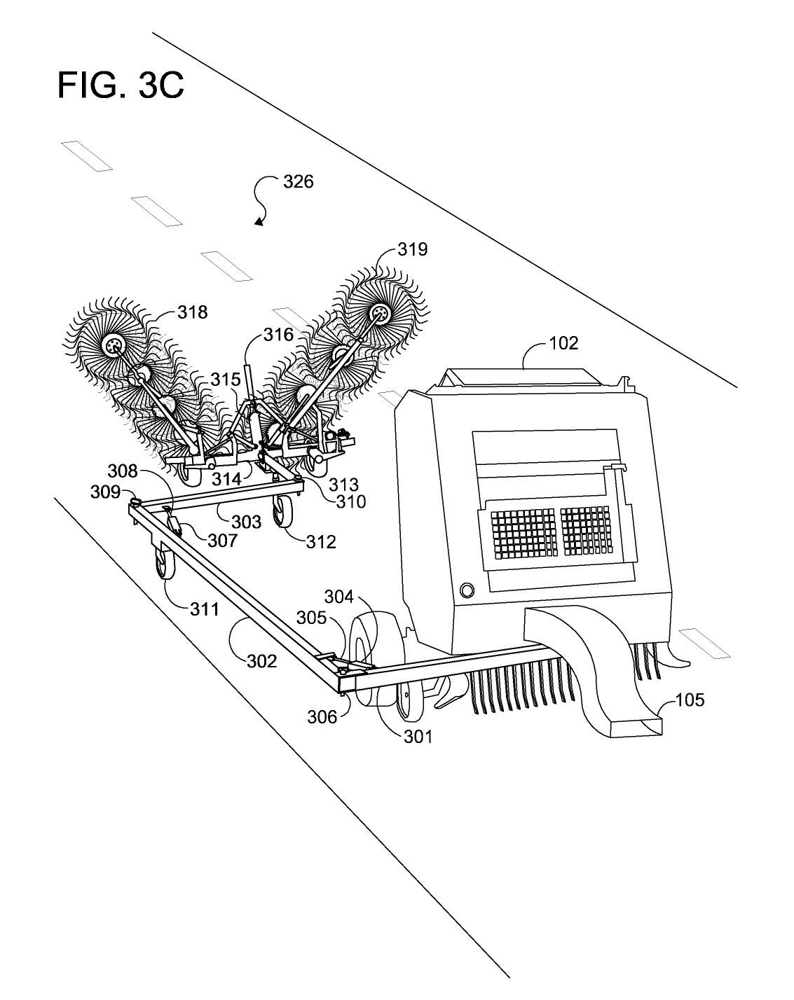

FIG. 3A is an oblique view of an embodiment of the extendable arm connecting a hay baler to a hay rake, the baler, arm and rake constituting a rake-arm-baler assembly with the extendable arm in an extended state, and the rake in a down position. The rake-arm-baler assembly includes the baler 102, the rake 103, and the extendable arm 100 connecting the rake 103 to the baler 102. In the embodiment shown, the rake-arm-baler assembly is being pulled by a tractor (not shown) via the baler towing arm 105 through a hayfield 300. The baler 102 is shown baling a previously raked row of hay 320, and creating bales of hay in the process 322, while the rake is being shown raking a new row of hay 324, according to a system similar to that which has been shown and described in connection with FIGS. 1 and 2, above.

The full rake-arm-baler assembly 500 includes a baler 502, the extendable arm 100, and a rake 504 (which is a V-caddy rake in this embodiment). The pivotally extendable arm 100 is capable of assuming a non-extended configuration for transporting the rake 103 behind the baler 102, as well as an extended configuration for enabling simultaneous operation of the baler 102 and rake 103. In this figure, the extendable arm 100 is in an extended state, thereby extending the rake-arm-baler assembly so as to enable simultaneous operation of the baler 102 and the rake 103.

A baler arm portion 301 is shown attached to the baler 102. In this embodiment, an intermediate arm portion 302 is attached to the baler arm portion 301, as well as to a rake arm portion 303. The intermediate arm portion 302 connects the baler arm potion 302 to the rake arm portion 303. In other embodiments of the extendable arm, rake arm portion 303 can be attached directly to the baler arm portion 301. Still other embodiments can include a plurality of intermediate arm portions.

In the embodiment shown, the baler arm portion 102 is rigidly attached to the front of the baler 502, so as not to be pivotable relative to the baler 502. However, in this embodiment the rake arm portion 104 is hingedly attached to the rake 504, so as to be pivotable relative to the rake 504. Different hinge arrangements can be contemplated in different embodiments.

In this embodiment, a rigid connection between the baler arm portion 301 and the baler towing arm 105 can help ensure that the extendable arm 100 holds the rake 103 in a fixed location relative to the baler 102. Also in this embodiment, the rake arm portion 303 and the rake 103 can be attached via a hinge, which can help ensure that the rake 103 faces the direction in which it is being pulled, regardless of any change in orientation of the rake arm portion 303, for example due to the extendable arm 100 moving between an extended state and a non-extended state.

The extendable arm 100 is a jointed arm having at least one arm extender that is located in proximity to an arm joint. The extendable arm 100 of the embodiment shown includes two hydraulic cylinders 304, 307 serving as arm extenders. Each of the hydraulic cylinders 304, 307 are mounted near a respective joint 306, 309 between two arm portions of the extendable arm 100. Each of the hydraulic cylinders 304, 307 are fastened to one arm portion of the extendable arm 100, and they include piston arms 305, 308 which are fastened to an adjacent arm portion on the opposite side of the respective hinge joint 306, 309 near which they are mounted.

In the embodiment shown, the two hydraulic cylinders 304, 307 of the extendable arm 100 are connected via the same set of hoses (not shown in this figure), so as to enable synchronized movement between the two joints 306, 309 of the extendable arm 100.

One hydraulic cylinder 304 is located at the joint 306 between the baler arm portion 301 and the intermediate arm portion 302. When fluid pressure is provided into a chamber of the cylinder that does not house the piston arm 305 (via hoses not shown in this figure), the piston arm 305 of the cylinder 304 is forced outward, thereby pushing the intermediate arm portion 302 about the hinge 306 and out away from the baler arm portion 301, consequently widening the angle between the baler arm portion 301 and the intermediate arm portion 302. Such movement of the intermediate arm portion 302 relative to the baler arm portion 301 can contribute to the extendable arm 100 moving from a non-extended state to an extended state.

When fluid pressure is provided into the chamber of the cylinder that does house the piston arm 305, the piston arm 305 is retracted back into the cylinder 304, thereby pulling the intermediate arm portion 302 about the hinge 306 and in towards the baler arm portion 301, consequently narrowing the angle between the baler arm portion 301 and the intermediate arm portion 302. Such movement of the intermediate arm portion 302 relative to the baler arm portion 301 can contribute to the extendable arm 100 moving from an extended state to a non-extended state.

In this embodiment, a caster wheel 311 is attached to the underside of the intermediate arm portion 302, thereby supporting the intermediate arm portion while also facilitating the movement of the intermediate arm portion 302, for example when the extendable arm is moving between an extended state and a non-extended state.

In the embodiment shown, the rake 103 includes a rake support frame 313 (which in this figure is represented as a T-bar with wheels), a rake lifting assembly 314 which includes a rake lifter 315, and two sets of rake wheels 318, 319. In the embodiment shown, the rake lifter 315 is another hydraulic cylinder 315. In the embodiment shown, the rake lifter 315 is connected to the arm extender cylinders 304, 307, via the same system of hoses (not shown in this figure) that provide fluid pressure to the arm extender cylinders. Therefore, movement of the rake lifting assembly is also synchronized with movement of the extendable arm 100 in the embodiment shown.

The rake lifter hydraulic cylinder 315 is located within the rake lifting assembly 314. When fluid pressure is provided into the rake lifter cylinder 315 (via a hose not shown in this figure), a piston arm 316 of the cylinder 315 is forced outward, thereby pushing the rake lifting assembly 314 upwards via a series of hinges, consequently raising the rake wheels 318, 319. Such movement of the rake lifting assembly 314 can contribute to the rake 103 moving from a down position (wherein the rake wheels 318, 319 are in contact with the ground and positioned so as to rake a windrow), into an up position (as shown in FIG. 3C, convenient for transporting).

FIG. 3B is another oblique view of the rake-arm-baler assembly of FIG. 3A, with the extendable arm in the process of moving into a non-extended state and the rake moving into an up position. In this figure, the piston arms 305, 308 of the cylinders 304, 307 mounted near the joints 306, 309 the extendable arm are in the process of retracting into their respective cylinders 304, 307, thereby moving the extendable arm 100 into a non-extended state by narrowing the angle between the baler arm portion 301 and the intermediate arm portion 302, as well as the angle between the intermediate arm portion 302 and the rake arm portion 303. Meanwhile, the piston arm 316 of the rake lifter cylinder 315 of the rake lifting assembly 316 is shown extending upwards out of the cylinder 315, thereby raising the rake lifting assembly 316 into a position so as to support the rake wheels 318, 319 in an up configuration.

FIG. 3C is another oblique view of the rake-arm-baler assembly of FIG. 3A, with the extendable arm in a non-extended state and the rake in an up position. In the embodiment shown, the piston arms 305, 308 of the cylinders 304, 307 mounted near the joints 306, 309 the extendable arm are fully retracted into their respective cylinders 304, 307, thereby positioning the extendable arm 100 in a non-extended state. Meanwhile, the piston arm 316 of the rake lifter cylinder 315 of the rake lifting assembly 316 is shown fully extended upwards out of the cylinder 315, thereby positioning the rake lifting assembly 316 so as to support the rake wheels 318, 319 in an up configuration. With the extendable arm 100 in the non-extended state and the rake 103 in the up configuration, the rake-arm-baler assembly can be easily transported. In the embodiment shown, the rake-arm-baler assembly is shown being towed via the baler towing arm 105 (by a tractor not shown in the figure) down the right-hand lane of a double-lane road 326.

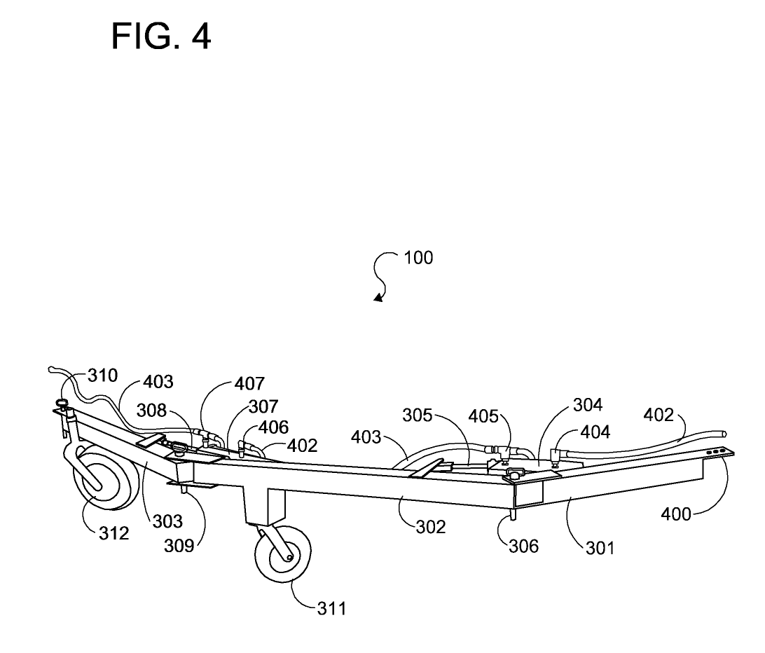

FIG. 4 is an oblique view of an embodiment of the extendable arm that is not connected to any other equipment. The embodiment of FIG. 4 is similar to the embodiment shown in FIG. 3A. In this figure, however, an arm-baler connection 400 for connecting the baler arm portion 301 of the extendable arm 100 to a baler is shown. The arm-baler connection 400 can be attached to the underside of a baler towing arm 105, for example. Also, hoses 402, 403 and valves 404, 405, 406, 407 responsible for delivering fluid pressure to the hydraulic cylinders are shown in this figure.

A piston arm extender hose 402 connects to valves 404, 406 which feed into chambers of the cylinders 304, 307 which do not house the respective piston arms 305, 308. This piston arm extender hose 402 can deliver fluid pressure into the chamber of the cylinder that does not house the piston arms 305, 308, thereby pushing the arm portions apart and consequently widening the angle between them. This action can move the extendable arm 100 from a non-extended state into an extended state.

A piston arm retractor hose 403 connects to valves 405, 407 which feed into chambers of the cylinders 304, 307 which do house the respective piston arms 305, 308. The piston arm retractor house 403 can deliver fluid pressure into the chamber of the cylinder that does house the piston arms 305, 308, thereby pushing the arm portions apart and consequently widening the angle between them. This action can move the extendable arm 100 from an extended state into a non-extended state.

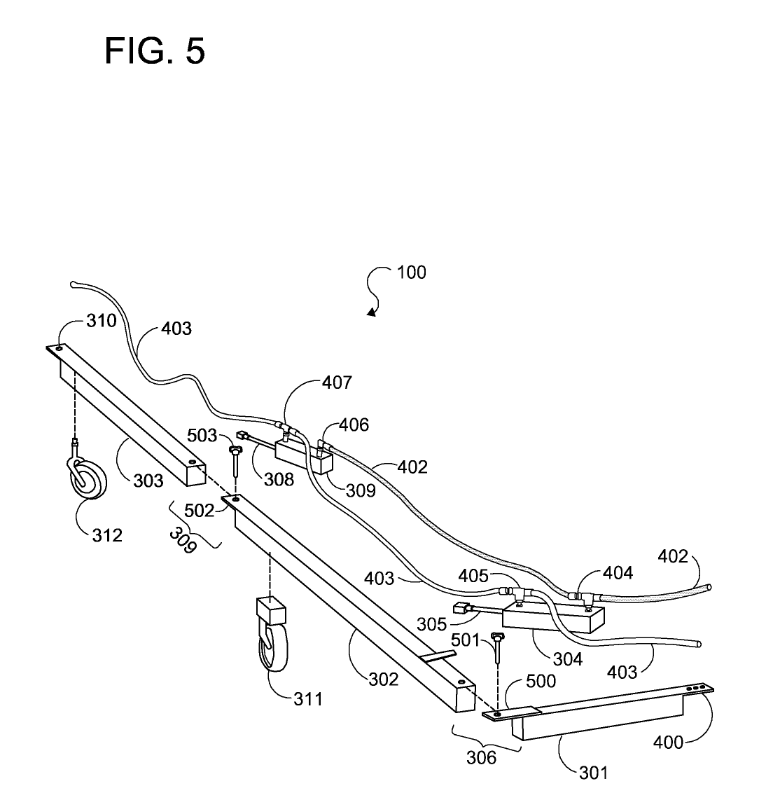

FIG. 5 is an exploded view of the embodiment of FIG. 4, showing the separate elements of the extendable arm, for clear identification of each element. The figure shows a baler arm portion slab 500 which extends the top surface of the baler arm portion. This baler arm portion slab 500 can be adapted to receive a hinge pin 501, and to securely overlap with an adjacent end of the intermediate arm portion 302, which can also be adapted to receive the hinge pin 501. The hinge pin 501 can connect the baler arm portion 301 to the intermediate arm portion 302 at a single point, while still allowing the intermediate arm portion 302 to pivot relative to the baler arm portion 301.

In the embodiment shown, the piston arm retractor hose 403 also leads beyond the rake arm portion 303, and connects to the rake lifter cylinder 315 itself. However, while the piston arm retractor hose 403 retracts the piston arms of the extendable arm extender cylinders 304, 307, this same hose performs an opposite action on the rake lifter cylinder 315, actually extending (as opposed to retracting) the piston arm 316 of the rake lifter cylinder 315.

Therefore, the piston arm retractor hose 403 (so named because it retracts the piston arms of the extendable arm cylinders), does not retract the piston arm 316 of the rake lifter cylinder 315. Instead, it actually extends the piston arm 316 of the rake lifter cylinder 315, thereby countering the force of gravity and enabling the rake lifting assembly 314 to lift the wheels 318, 319 of the rake 103 into an up position.

Therefore, as the piston arm retractor hose 403 retracts the piston arms 305, 308 into their respective extendable arm extender cylinders 304, 307 when it applies fluid pressure, it simultaneously extends the piston arm 316 of the rake lifter cylinder 315. This arrangement results in the action shown in FIGS. 3B and 3C. The wheels 318, 319 of the rake 103 are raised at the same time that the extendable arm 100 is moved into a non-extended state (as shown in FIGS. 3B and 3C).

Alternatively, when the piston arm extender hose 402 applies fluid pressure to the extendable arm cylinders 304, 307 so as to extend the extendable arm 100 into its extended state, the wheels 318, 319 of the rake 103 are able to descend into the down position, via the force of gravity which is no longer resisted by fluid pressure from the piston arm retractor hose 403.

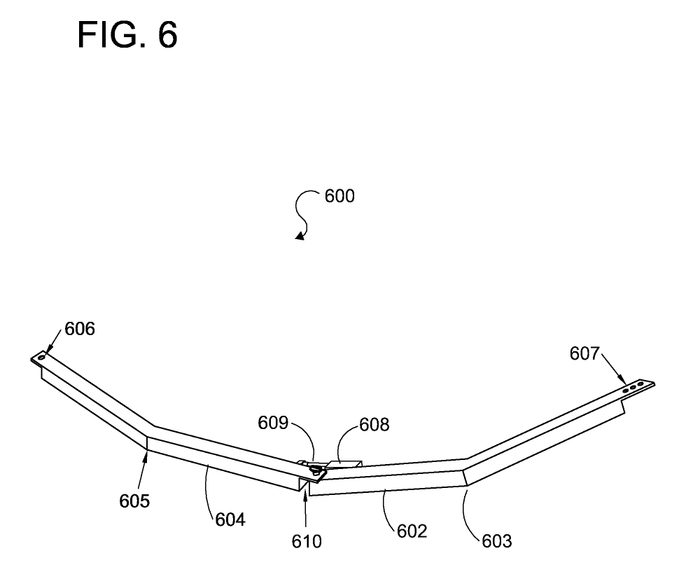

FIG. 6 is an oblique view of an alternative embodiment of the extendable arm. The embodiment shown includes a baler arm portion with an angled bend, connected to a rake arm portion with an angled bend, via a single joint which can be pivoted with the action of a single arm extender.

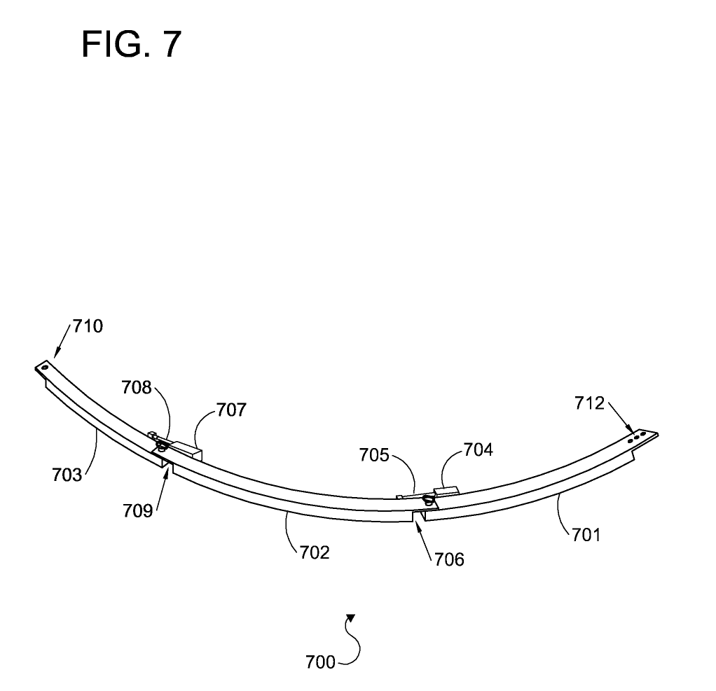

FIG. 7 is an oblique view of another alternative embodiment of the extendable arm. The embodiment shown includes a curved baler arm portion, a curved intermediate portion, and a curved rake arm portion.

Arm portions of the extendable arm can be made of metal or any other material suitable for their function. The arm portions can be straight, angled, curved, and/or any other shape suitable for their function and readily apparent to one of ordinary skill in the art.

Arm extenders of the arm can be automatically powered, and/or manually operable. An arm extender or extenders can be a hydraulic or pneumatic cylinder, a hand crank, and/or any other mechanism apparent to one of ordinary skill in the art, which is capable of portions of the extendable arm relative to each other, so as to change the relative positions of the baler and rake.

In some embodiments, the extendable arm can also include a locking mechanism capable of locking the extendable arm into position in the non-extended state and/or the extended state. The extendable arm can also be configured so as to be easily attachable to a baler and a rake.

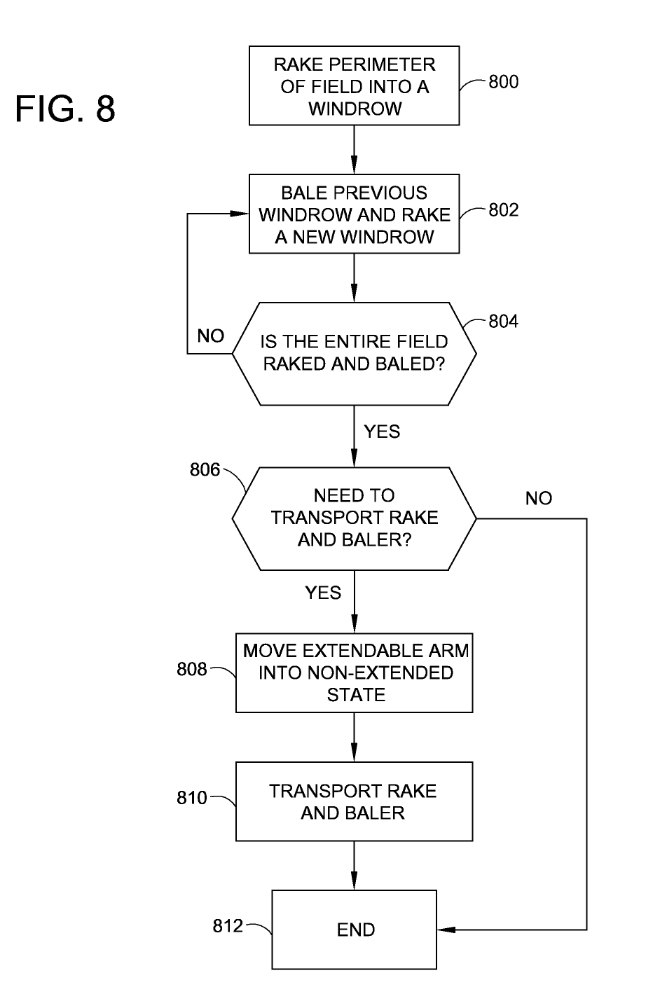

FIG. 8 is a flowchart detailing the steps of operation of the extendable arm in the context of its use with a hay baler and a hay rake, for raking and baling a hayfield. First, with the extendable arm in the extended position (and the rake in the down position), the rake-arm-baler assembly is driven so as to enable the rake to rake a row of hay around the perimeter of the hayfield 800. The rake-arm-baler assembly is driven so that the rake is extended exterior to the baler, with the rake running along the perimeter of the field while the baler is driven in a lap interior to the perimeter.

Next, the rake-arm-baler assembly is turned around and driven in the opposite direction, so as to drive the baler around the perimeter of the field, with the rake positioned interior to the baler. This action enables the baler to bale the previously raked row of hay, while enabling the rake to rake a new row of hay interior to the previously raked row of hay 802. Until the entire field of hay is raked and baled 804, this simultaneous action of the baler and rake continues 802, with the rake-arm-baler assembly moving ever closer to the center of the hayfield.

Once the entire hayfield is raked and baled 804, the rake-arm-baler assembly can be moved into a new configuration for easy transport 806. This includes moving the extendable arm into its non-extended state 806 (and if the rake-arm-baler assembly is so configured, also moving the rake wheels into an up position). Finally, the rake-arm-baler assembly is transported with the extendable arm in the non-extended state and the rake in the up position (as visually depicted in FIG. 3C) 810.

Other modifications and implementations will occur to those skilled in the art without departing from the spirit and the scope of the invention as claimed. Accordingly, the above description is not intended to limit the invention except as indicated in the following claims.

What is claimed is:

1. An extendable jointed arm for enabling a hay baler to pull a hay rake during both easy transport, and simultaneous operation, of the hay baler and the hay rake, the extendable jointed arm comprising:
a baler arm portion, the baler arm portion being configured to attach to a hay baler;
a rake arm portion, the rake arm portion being configured to attach to and support a hay rake;
at least one articulated joint, the baler arm portion and the rake arm portion being connected via the at least one articulated joint; and
at least one arm extender, cooperative with the at least one articulated joint, the at least one arm extender being capable of bending the at least one articulated joint, thereby moving the extendable arm between a non-extended state and an extended state,
the extendable arm positioning the hay rake and the hay baler relative to each other so as to enable the hay rake and the hay baler to operate simultaneously, when in the extended state, and
the extendable arm positioning the hay rake behind the hay baler for facilitating transport of the rake and hay baler, when in the non-extended state.

2. The extendable arm of claim 1, wherein the at least one arm extender is in communication with a rake lifter, the rake lifter being capable of lifting wheels of the hay rake.

3. The extendable arm of claim 1, wherein the extendable arm is capable of positioning the rake substantially behind the baler, when the extendable arm is in the non-extended state.

4. The extendable arm of claim 1, wherein the extendable arm is capable of positioning the rake relative to the baler so as to enable the rake to rake a row of hay parallel to a row of hay being baled by the baler, when the extendable arm is in the extended state.

5. The extendable arm of claim 1, wherein the rake arm portion is directly connected to the baler arm portion via a single articulated joint.

6. The extendable arm of claim 1, further comprising at least one intermediate arm portion connecting the baler arm portion with the rake arm portion.

7. The extendable arm of claim 1, wherein the baler arm portion is rigidly attached to the front of the baler, so that the baler arm portion is immovable relative to the baler.

8. The extendable arm of claim 1, wherein the rake arm portion is pivotably attached to the rake via a hinge, so that the rake arm portion is in pivotable relationship with the rake.

9. The extendable arm of claim 1, wherein movement of the at least one arm extender is power-assisted.

10. The extendable arm of claim 1, wherein the at least one arm extender includes one of:
a powered hydraulic cylinder; and
a powered pneumatic cylinder.

11. The extendable arm of claim 1, wherein the at least one arm extender is manually movable.

12. The extendable arm of claim 1, wherein the at least one arm extender includes a hand crank.

13. The extendable arm of claim 1, further comprising:
a locking mechanism capable of locking the extendable arm into position in at least one of:
the non-extended state; and
the extended state.

14. The extendable arm of claim 1, wherein the baler arm portion is one of:
straight;
angled; and
curved.

15. The extendable arm of claim 1, wherein the rake arm portion is one of:
straight;
angled; and
curved.

16. The extendable arm of claim 1, wherein metal is used to make at least one of the baler arm portion and the rake arm portion.

17. The extendable arm of claim 1, further comprising:
at least one wheel supporting at least one of:
the rake arm portion; and
the baler arm portion.

18. The extendable arm of claim 17, wherein the at least one wheel is a caster wheel.

19. The extendable arm of claim 17, wherein at least one wheel supports the rake arm portion.

20. The extendable arm of claim 17, wherein at least one wheel supports the baler arm portion.
